(19) United States
(12) Patent Application Publication
(10) Pub. No.: US 2024/0248278 A1
(43) Pub. Date: Jul. 25, 2024

(54) IMAGING OBJECTIVE

(71) Applicant: Nextlens Switzerland AG, Dietikon (CH)

(72) Inventors: Manuel Aschwanden, Dietikon (CH); Markus Geissner, Dietikon (CH)

(73) Assignee: Nextlens Switzerland AG, Dietikon (CH)

(21) Appl. No.: 18/419,596

(22) Filed: Jan. 23, 2024

(30) Foreign Application Priority Data
Jan. 23, 2023 (DE) 102023101570.2

(51) Int. Cl. G02B 7/02; G02B 3/12

(52) U.S. Cl. CPC G02B 7/023; G02B 3/12

(57) ABSTRACT

Imaging objective comprising a lens barrel, a rigid lens and a tunable lens, wherein
the lens barrel (300) has an opening (301) extending through the lens barrel (300) along an optical axis (400),
the lens barrel (300) has an inner surface (300b) adjacent to the opening (301),
the lens barrel (300) comprises an outer surface (300a) facing away from the inner surface (300b), and wherein the lens barrel (300) has a wall thickness, which is defined by the minimal distance between the inner surface (300b) and the outer surface (300a) at each point, wherein the wall thickness varies in a reference plane, wherein the reference plane extends perpendicularly with respect to the optical axis (400).

### CROSS REFERENCE TO RELATED APPLICATIONS

Benefit is claimed to German Patent Application No. DE 102023101570.2, filed Jan. 23, 2023, the contents of which are incorporated by reference herein in their entirety.

### FIELD

The present disclosure concerns an imaging objective which is arranged to depict an object plane onto an image plane. In particular, the imaging objective may be part a of a camera device, comprising an image sensor which is arranged at the image plane.

### BACKGROUND

Regarding such imaging objectives, it is desirable to be able to provide a lens barrel for such a device that allows precise alignment of optical components in the lens barrel.

Furthermore, it is desirable to provide an actuation of a tunable lens of such a device that is highly efficient in order to reduce the energy needed for tuning the tunable lens which has the added benefit of introducing less heat into the system.

One way to allow for an efficient actuation is to use a voice coil actuator that utilizes only a horizontal portion of a magnetic field extending through the coil surrounding the corresponding magnet in a horizontal plane. Thus, the coil has to be as close as possible to the magnet, to be exposed to a strong magnetic field.

However, due to the fact, that lens barrels produced by injection molding typically comprise a constant minimum wall thickness in the range from 400 μm to 500 μm, the distance of the coil to the magnet is often too big for a satisfactorily efficient actuation.

### SUMMARY

Based on the above, the problem to be solved by the present invention is to provide an imaging objective that is improved with respect to at least one of the above-described difficulties.

This problem is solved by an imaging objective having the features of claim 1. Preferred embodiment of this aspect of the present invention are stated in the dependent claims and are described below.

According to claim 1, an imaging objective is disclosed, comprising: a lens barrel, a rigid lens, and a tunable lens, wherein the lens barrel has an (e.g. elongated) opening extending through the lens barrel along an optical axis of the imaging objective, wherein the lens barrel has an inner surface adjacent to the opening, the lens barrel comprises an outer surface facing away from the inner surface, and wherein the lens barrel has a wall thickness, which is defined by the minimal distance between the inner surface and the outer surface at each point, wherein the wall thickness varies in a reference plane, wherein the reference plane extends perpendicularly with respect to the optical axis.

In other words, particularly, there is at least one reference plane extending perpendicularly with respect to the optical axis, wherein in regions intersecting the reference plane the wall thickness is not constant.

Further described herein is an imaging objective (1) comprising a lens barrel (300), a rigid lens (202) and a tunable lens (201), wherein the lens barrel (300) has an opening (301) extending through the lens barrel (300) along an optical axis (400), the lens barrel (300) has an inner surface (300b) adjacent to the opening (301), the lens barrel (300) comprises an outer surface (300a) facing away from the inner surface (300b), and wherein the lens barrel (300) has a wall thickness, which is defined by the minimal distance between the inner surface (300b) and the outer surface (300a) at each point, wherein the wall thickness varies in a reference plane, wherein the reference plane extends perpendicularly with respect to the optical axis (400).

### BRIEF DESCRIPTION OF THE DRAWINGS

In the following, embodiments of the present invention as well as further features and advantages of the present invention shall be described with reference to the Figures, wherein

FIG. 1 shows an exemplary embodiment of an imaging objective in a schematic sectional view;

FIG. 2, FIG. 3, FIG. 4, and FIG. 5A show exemplary embodiments of a coil and a magnet of an imaging objective in a schematic top view along the optical axis;

FIGS. 5B-5C show an exemplary embodiment of an imaging objective in a schematic sectional view;

FIGS. 6A-6B show a simulation of the Lorentz force contribution along the optical axis in an exemplary embodiment of a coil and a magnet of an imaging optical system; And

FIGS. 7A-7F show a possible process for producing an imaging objective according to the present invention.

### DETAILED DESCRIPTION

According to a preferred embodiment of the present invention, the lens barrel extends perimetrically around the rigid lens and/or the tunable lens. In particular, the rigid lens and/or the tunable lens is arranged in the opening.

Furthermore, according to a preferred embodiment, the imaging objective comprises an actuator, the actuator comprising a coil and a magnet, wherein the actuator is arranged to alter a tuning state of the tunable lens (for example by curving at least one membrane of the tunable lens as described further below).

Further, in a preferred embodiment, the coil and/or the magnet extend perimetrically around the optical axis. Preferably, either the coil is arranged in the opening of the lens barrel and the magnet extends perimetrically around the lens barrel, or the magnet is arranged in the opening and the coil extends perimetrically around the lens barrel. According to a preferred embodiment, a distance between the coil and the magnet varies along the perimeter of the magnet.

According to yet another preferred embodiment the wall thickness between the coil and the magnet varies along the perimeter of the magnet. In particular, either the coil or the magnet is arranged in the reference plane. Further, in a preferred embodiment, the global minimum of the wall thickness is located between the coil and the magnet.

Further, according to a preferred embodiment, a global minimum of the wall thickness is smaller or equal to 2 mm, particularly smaller or equal to 1 mm, particularly smaller or equal to 500 μm.

Furthermore, according to a preferred embodiment of the present invention, portions of the perimeter of the lens barrel along which the wall thickness is the global minimum together make up at least 50% of the perimeter of the lens barrel.

According to yet another preferred embodiment, the magnet is magnetized along the optical axis.

Furthermore, in a preferred embodiment, the magnet comprises an annular shape, particularly in a virtual plane extending perpendicularly with respect to the optical axis, having a circular perimeter (in said virtual plane).

In contrast thereto, according to a preferred embodiment the coil comprises a non-circular shape, particularly in a virtual plane extending perpendicular to the optical axis. Particularly, in specific embodiments, the coil can comprise a shape selected from the following shapes: a rectangular shape, a quadratic shape, a triangular shape, a pentagonal shape, a polygonal shape.

Furthermore, according to a preferred embodiment, the lens barrel comprises through holes extending from the inner surface to the outer surface of the lens barrel, respectively. Preferably, said through holes each extend in a direction obliquely with respect to the optical axis.

In a preferred embodiment, said through holes are arranged along a perimeter of the lens barrel, particularly in a virtual plane extending perpendicularly to the optical axis.

In a preferred embodiment, the coil or the magnet covers the through holes on the outer surface of the lens barrel and partially protrudes with a portion into the opening of the lens barrel through the respective through hole, such that in particular in the region of the respective through hole there is a (global) minimal distance between the coil and the magnet.

Furthermore, according to a preferred embodiment, the tunable lens comprises a container filled with a liquid, the container comprising a first and a second membrane arranged opposite one another, each of the membranes being connected to a circumferential wall of the container with the liquid being arranged between said membranes. Particularly, the first and second membranes as well as the liquid are transparent to allow passage of light therethrough. Furthermore, the first and the second membrane are preferably elastically deformable.

Furthermore, according to a preferred embodiment, the imaging objective comprises a rigid front lens (or alternatively a rigid optical element such as a protection window) connected to the lens barrel and arranged on the first membrane and particularly forming a first lens/optical element of the imaging objective along an optical path of the imaging objective.

Furthermore, according to a preferred embodiment of the invention, the imaging objective comprises a spring structure preferably arranged in said opening of the lens barrel and connecting the magnet or the coil to the lens barrel, particularly to its inner surface, to support the magnet or the coil and to allow movement of the magnet or coil along the optical axis, wherein the spring structure provides a restoring force for returning the container/tunable lens into an initial state when the actuator is turned off.

In a preferred embodiment, the container is supported on the spring structure, particularly via the magnet or the coil. Alternatively, or in addition, the container is supported on the rigid front lens via the first membrane according to a preferred embodiment. Particularly, supporting the container on the first membrane and on the spring structure prevents a tilt of the container (and particularly magnet if the container is supported on the spring structure via the magnet).

In particular, preferably, the lens barrel is fabricated by molding, and the shape of the inner surface is defined by means of a single pin.

Furthermore, according to a preferred embodiment, the inner surface of the lens barrel is defined by a single-pieced mold cavity.

Particularly, in case a hard stop is provided for the tunable lens, the hard stop can be provided for a window element or rigid lens connected to the membrane of the tunable lens or for a spring structure of the tunable lens, via which spring structure the container of the tunable lens is supported on the lens barrel/hard stop.

Preferably, the notion “single pieced manner” means that the inner surface is a continuous inner surface over the whole length of the lens barrel along the optical axis. Preferably, the lens barrel is a monolithic body that can be formed from a single homogenous material.

Thus, particularly, this embodiment of the imaging objective described herein makes use of the idea that precise alignment of optical components is required to achieve a high imaging quality. The most precise alignment is achieved by fabricating hard stops for the optical components in a single pieced manner.

Furthermore, according to a preferred embodiment, the hard stop may be defined by an edge extending perimetrically around the optical axis. In particular, the inner surface enables precise relative alignment of the rigid lens and/or the tunable lens.

According to a preferred embodiment, a diameter of the opening is measured in a direction perpendicular to the optical axis, and the diameter changes monotonically along the optical axis. In particular, the opening may comprise multiple sections with different diameters and an edge between two sections with different diameters forming a hard stop. The lens barrel can comprise several such hard stops.

As described above, in all embodiments, the position of the magnet and the coil can in principle be interchanged. In particular, this can mean that the coil is arranged on the outer surface (and may cover the through holes) and the magnet is arranged in the opening of the lens barrel and can then support the container. Furthermore, in this case, the magnet can be supported on the spring structure in turn.

In the other case the magnet can be arranged on the outer surface (and may cover the through holes), Here, the coil is arranged in the opening of the lens barrel and can then support the container. Furthermore, in this case, the coil can be supported on the spring structure in turn.

Elements which are identical, similar or have the same effect are given the same reference numeral in the Figures. The Figures and the proportions of the elements shown in the Figures to one another are not to be regarded as to scale, unless units are expressly indicated. Rather, individual elements may be shown exaggeratedly large for better representability and/or for better comprehensibility.

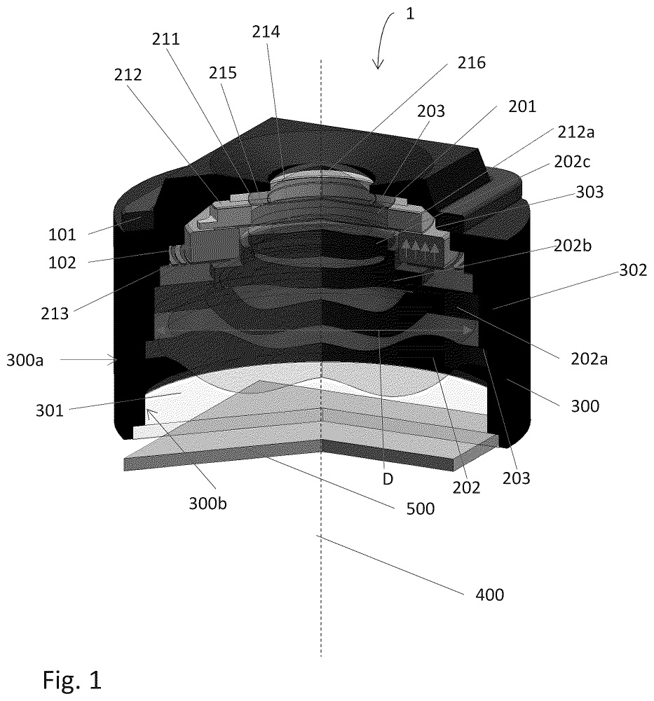

FIG. 1 shows a preferred embodiment of an imaging objective 1 in a schematic sectional view.

As shown in FIG. 1, the imaging objective 1 comprises a lens barrel 300, a rigid lens 202 and a tunable lens 201, wherein the lens barrel particularly comprises a circumferential wall 302 that surrounds an opening 301 that extends through the lens barrel 300 along an optical axis 400 of the imaging objective 1. The lens barrel 300 comprises an inner surface 300b facing the opening 301, wherein the inner surface 300b preferably provides at least one hard stop 203 for the rigid lens 202 and/or the tunable lens 201 along the optical axis 400, and wherein the inner surface 300b is preferably fabricated (e.g. injection molded) in a single pieced manner.

As further indicated in FIG. 1 a diameter D of the opening 301 is measured in a direction perpendicular to the optical axis 400, wherein said diameter D changes monotonically along the optical axis 400 so as to form steps having edges that serve as the respective hard stop 203 for the rigid lens 202 and/or for the tunable lens 201.

Furthermore, as shown in FIG. 1, the lens barrel 300 comprises an outer surface 300a that faces away from the inner surface 300b. The wall 302 of the lens barrel 300 comprises a wall thickness that corresponds to the minimal distance between the inner surface 300b and the outer surface 300a at each point. This wall thickness varies in a reference plane that extends perpendicularly with respect to the optical axis 400.

The imaging objective 1 can form part of a camera that comprises a sensor 500 as shown in FIG. 1 onto which the imaging objective 1 projects an image.

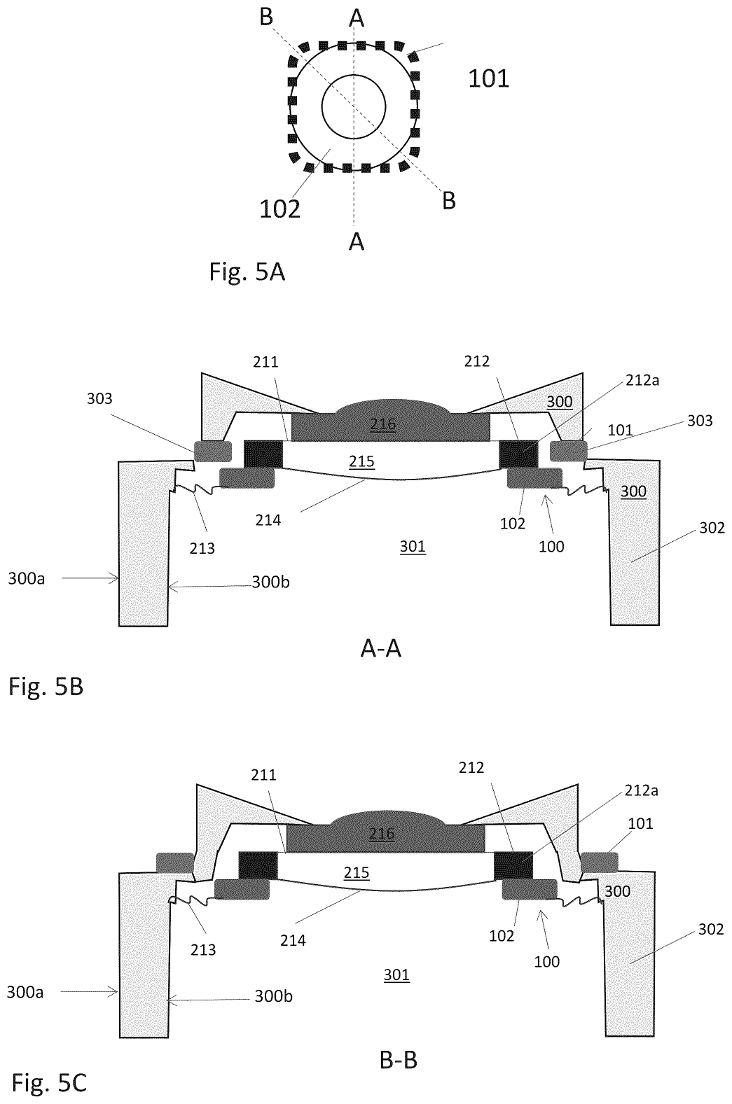

For tuning the tunable lens, the imaging objective 1 comprise an actuator 100 that employs a coil 101 and a magnet 102 to alter tuning state of the tunable lens, e.g. a curvature of a membrane 214 of the tunable lens 201 (cf. also FIGS. 5A and 5B) which adjusts the optical power of the tunable lens 201 to a desired value.

In a top view the magnet 102 and the coil 101 have a non-constant distance with respect to each other. In regions where the coil-magnet distance is larger, the lens barrel 300 may e.g. have wall thickness in the region of 400 microns to 500 microns. In regions where the coil-magnet distance is smaller, the lens barrel 300 has a wall thickness of less than 400 microns, or the lens barrel 300 has recesses, particularly through holes 300, extending from the inner surface 300b to the outer surface 300a. In particular, during production of the lens barrel 300, a single injection molding pin forms the inner surface 300b. High precision of the inner surface 300b of lens barrel 300, leads to high precision positioning of optical components, e.g. of (tunable lens/201 rigid lens 202).

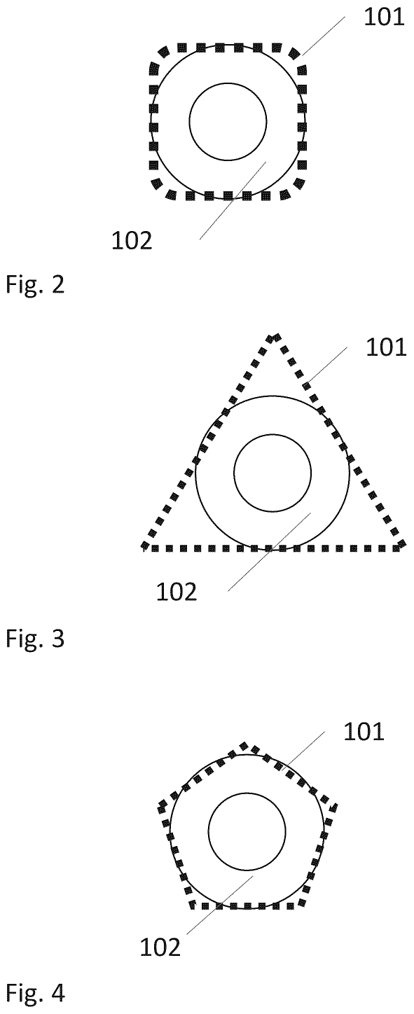

FIGS. 2, 3, 4 and 5A show exemplary embodiments of a coil 101 and a magnet 102 of an imaging objective 1 in a schematic top view along the optical axis 400. In all embodiments the magnet 102 has a circular shape as seen in the top view along the optical axis 400. In particular the magnet 102 is magnetized along the optical axis 400. The coil 101 has a non-circular shape. The coil 101 may have a rectangular or a quadratic shape (FIG. 2), a triangular shape (FIG. 3) or a pentagonal shape (FIG. 4). A distance between the coil 101 and the magnet 102 therefore varies along the perimeter of the coil. In particular, the variation in the coil magnet distance is rotationally symmetric with respect to the optical axis, to prevent a tilt of the magnet 102 during actuation. Particularly, this rotational symmetry can be an n-fold rotational symmetry.

Furthermore, FIGS. 5B and 5C show an exemplary embodiment of an imaging objective 1 according to the present invention in a schematic sectional view. Here, the coil 101 preferably comprises a quadratic shape as shown in FIG. 5A for instance, but may also have another geometry as described herein for example.

Particularly, the tunable lens 201 is a fluidic tunable lens 201 and therefore comprises a container 212 (also denoted as lens core) that delimits a volume that is filled with a transparent liquid 215. Further, the container 212 comprises a first and a second membrane 211, 214 which are transparent and elastically deformable. These membranes 211, 214 arranged opposite to one another, wherein each of the membranes 211, 214 is connected to a circumferential wall 212a of the container 212 with the liquid 215 being arranged between said membranes 211, 214.

Furthermore, the imaging objective 1 comprises a rigid window element 216 connected to the lens barrel 300 and arranged on the first membrane 211. The rigid window element 216 is preferably bonded to the first membrane 211 and may form a rigid lens. Due to the fact that the container 212 is thereby supported by the first membrane 211, the latter is also denoted as mounting membrane 211.

As shown in FIGS. 5B and 5c, the container 212 comprises a spring structure 213 connected to the inner surface 300b of the lens barrel 300, wherein the spring structure 213 also supports the magnet 102 on which the circumferential wall 212a of the container 212 rests, so that the latter is supported on the spring structure 213 via the magnet 102.

Having the tunable lens 201 beared by the first membrane 211 and the spring structure 213 helps to prevent a tilt of the magnet 102/container 212.

In this configuration, the second membrane 214 forms an optical membrane 214 having a curvature that can be adjusted by means of the actuator 100, i.e. by applying an electrical current to the coil 101 and thereby moving the magnet 102 along the optical axis 400 which-depending on the direction of the electrical current in the coil 101-causes the container 212 to be pushed against the window element 216 causing the second membrane 214 to e.g. bulge further out or to decrease in curvature when the magnet 102 is moved in the opposite direction.

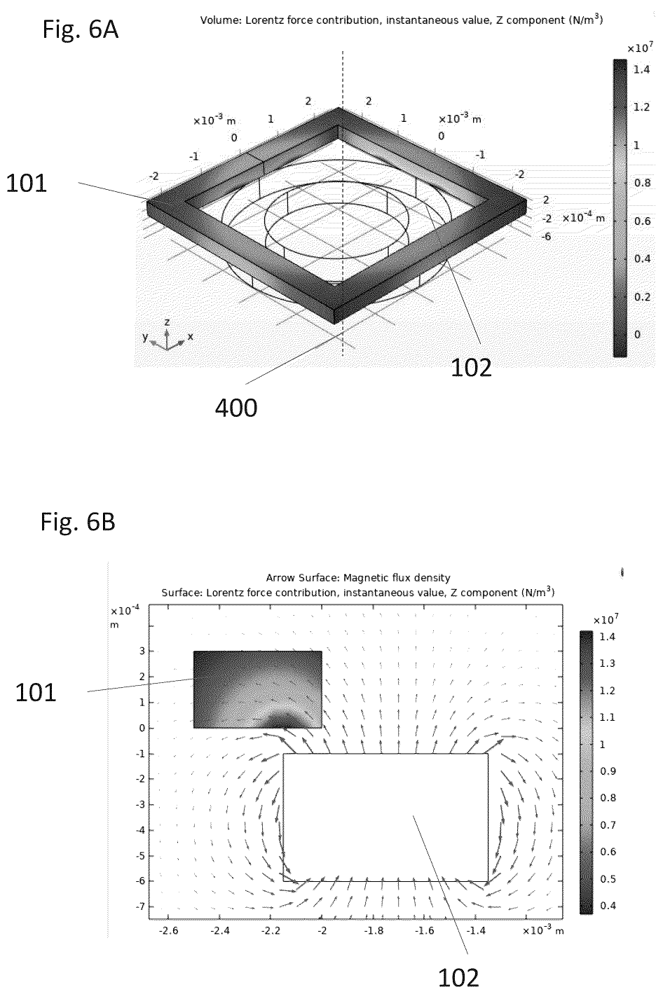

Due to the fact that the coil is non-circular, it comprises portions that come closer to the annular magnet 102 as indicated in FIGS. 5A and 5B. These portions preferably protrude into the opening 301 of the lens barrel through lateral through holes 303 formed in the wall 302 of the lens barrel 300 as shown in FIG. 5B, thus realizing a minimal distance to the magnet 102 which increases the efficiency of the voice coil actuator 100. This type of coil arrangement is also shown in FIG. 1. FIGS. 6A and 6B show a simulation of the Lorentz force contribution along the optical axis in an exemplary embodiment of a coil and a magnet of an imaging objective indicating the increased efficiency of a configuration having a quadratic coil 101 and an annular magnet 102.

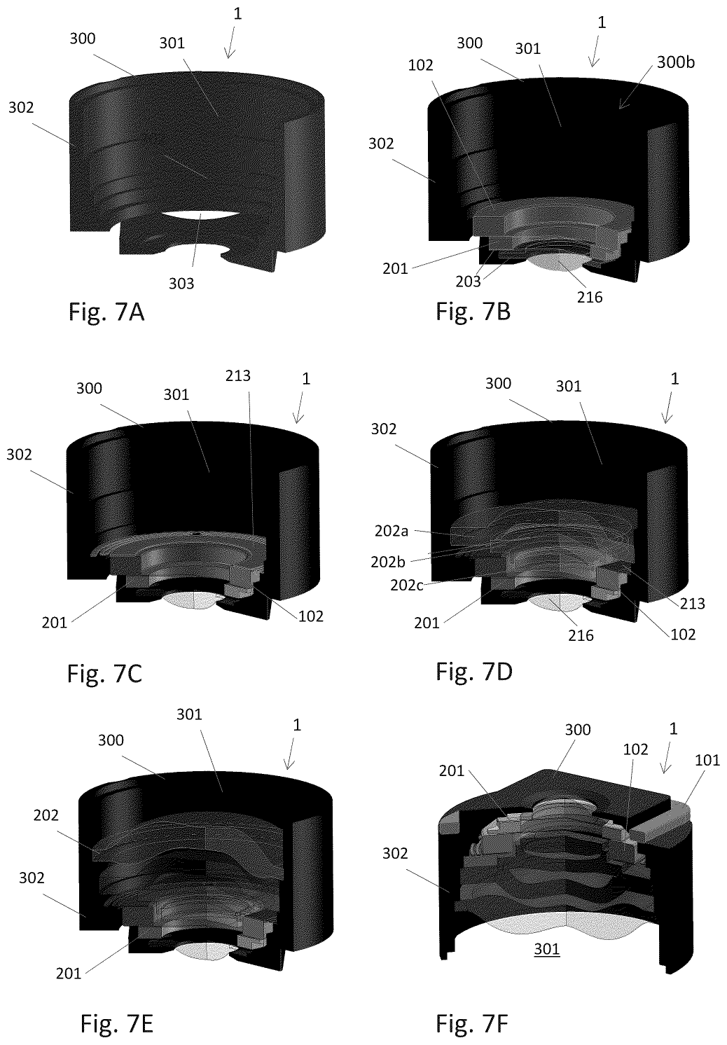

Finally, FIG. 7A to 7F show individual steps of a further aspect of the present invention relating to a method for producing an imaging object 1 according to the present invention as described herein. According thereto, in a first step, a lens barrel 300 is provided (cf. FIG. 7A) that may comprise said through holes 303 in a circumferential wall 302 of the lens barrel 300. The lens barrel 300 may be arranged with a front side receiving said window element 216 pointing downwards in the vertical direction.

Then the rigid window element 216 forming e.g. a top lens, the tunable lens 201 and the magnet 102 are glued arranged in the opening 301 of the lens barrel 300 and glued to its inner surface 300b which provides hard stops for the window element 216 and the tunable lens 201 (cf. FIG. 7B).

Thereafter, the spring structure 213 is arranged in the opening 301 and glued to the inner surface 300b of the lens barrel 300, wherein the spring structure 213 is also attached to the magnet 102 (cf. FIG. 7C).

Then, a middle lens group comprised e.g. of rigid lenses 202c, 202b, 202a (cf. also FIG. 1) is assembled into the opening 301 of the lens barrel 300 (cf. FIG. 7D).

Thereafter, a rigid bottom lens 202 (cf. also FIG. 1) is assembled into the opening 301 of the lens barrel 300 (cf. FIG. 7E).

Finally, as indicated in FIG. 7F, the coil 101 is attached to the outer surface 300a of the lens barrel 300 and the magnet 102 is magnetized.

The present invention is not limited to the embodiments by the description based thereon. Rather, the invention includes any new feature as well as any combination of features, which in particular includes any combination of features in the claims, even if that feature or combination itself is not explicitly stated in the claims or embodiments.

### LIST OF REFERENCE SIGNS

1 Imaging objective
100 Actuator
101 Coil
102 Magnet
201 Tunable lens
202 Rigid lens (bottom lens)
202a Rigid lens (middle lens group)
202b Rigid lens (middle lens group)
202c Rigid lens (middle lens group)
203 Hard stop
211 Mounting membrane (first membrane)
212 Container
213 Spring
214 Optical membrane (second membrane)
215 Liquid volume
216 Rigid window element (e.g. rigid top lens)
300 Lens barrel
300b Inner surface of lens barrel
300a Outer surface of lens barrel
301 Opening of lens barrel
302 Wall of lens barrel
303 Through holes of lens barrel
400 Optical axis
500 Sensor

We claim:

1. An imaging objective (1) comprising a lens barrel (300), a rigid lens (202) and a tunable lens (201), wherein
the lens barrel (300) has an opening (301) extending through the lens barrel (300) along an optical axis (400),
the lens barrel (300) has an inner surface (300b) adjacent to the opening (301),
the lens barrel (300) comprises an outer surface (300a) facing away from the inner surface (300b), and wherein the lens barrel (300) has a wall thickness, which is defined by the minimal distance between the inner surface (300b) and the outer surface (300a) at each point, wherein the wall thickness varies in a reference plane, wherein the reference plane extends perpendicularly with respect to the optical axis (400), wherein
the imaging objective further comprises an actuator (100) with a coil (101) and a magnet (102), wherein the actuator (100) is arranged to alter a tuning state of the tunable lens, and wherein
wherein the coil (101) is arranged in the opening (301) of the lens barrel (300) and the magnet (102) extends perimetrically around the lens barrel (300), or wherein the magnet (102) is arranged in the opening (301) of the lens barrel (300) and the coil (101) extends perimetrically around the lens barrel (300).

2. The imaging objective according to claim 1, wherein the coil (101) and/or the magnet (102) extend perimetrically around the optical axis (400).

3. The imaging objective according to claim 1, wherein a distance between the coil (101) and the magnet (102) varies along the perimeter of the magnet (102).

4. The imaging objective according to claim 3, wherein the variation of the distance between the coil (101) and the magnet (102) along the perimeter of the coil (101) is rotationally symmetric, particularly so as to prevent a tilt of the magnet (102) during actuation of the actuator (100).

5. The imaging objective according to claim 1, wherein the wall thickness between the coil (101) and the magnet (102) varies along the perimeter of the magnet (102).

6. The imaging objective according to claim 1, wherein a global minimum of the wall thickness is between the coil (101) and the magnet (102).

7. The imaging objective according to claim 6, wherein the global minimum of the wall thickness is smaller or equal to 2 mm, particularly smaller or equal to 1 mm, particularly smaller or equal to 500 microns.

8. The imaging objective according to claim 6, wherein portions of the perimeter of the lens barrel (300) along which the wall thickness is the global minimum together make up at least 50% of the perimeter of the lens barrel (300).

9. The imaging objective according to claim 1, wherein the magnet (102) is magnetized along the optical axis (400).

10. The imaging objective according to claim 1, wherein the magnet (102) comprises an annular shape having a circular perimeter.

11. The imaging objective according to claim 1, wherein the coil (101) comprises a non-circular shape.

12. The imaging objective according to claim 1, wherein the coil (101) comprises one of: a rectangular shape, a quadratic shape, a triangular shape, a pentagonal shape, a polygonal shape.

13. The imaging objective according to claim 1, wherein the lens barrel (300) comprises through holes (303) extending from the inner surface (300b) to the outer surface of the lens barrel (300), wherein preferably said through holes (303) are arranged along a perimeter of the lens barrel (300).

14. The imaging objective according to claim 13, wherein the coil (101) or the magnet (102) covers said through holes (303) and partially protrudes with a respective portion into the opening (301) of the lens barrel (300) through the respective through hole (303), such that in particular in the region of the respective through hole (303) there is a minimal distance between the coil (101) and the magnet (102).

15. The imaging objective according to claim 1, wherein the tunable lens (201) comprises a container (212) filled with a liquid (215), the container (212) comprising a first and a second membrane (211, 214) arranged opposite one another, each of the membranes (211, 214) being connected to a circumferential wall (212a) of the container (212) with the liquid (215) being arranged between said membranes (211, 214).

16. The imaging objective according claim 15, wherein the imaging objective comprises a rigid window element (216) connected to the lens barrel (300) and arranged on the first membrane (211), wherein particularly the window element (216) forms a rigid lens.

17. The imaging objective according to claim 16, wherein the imaging objective comprises a spring structure (213) arranged in said opening (301) of the lens barrel (300) and connecting the magnet (102) or the coil (101) to the lens barrel (300).

18. The imaging objective according to claim 15, wherein the container (212) is supported on the spring structure (213), particularly via the magnet (102) or the coil (101), and/or wherein the container (212) is supported on the window element (216) via the first membrane (211).

19. The imaging objective according to claim 1, wherein the inner surface (300b) is defined by a single-pieced mold cavity.

20. The imaging objective according to claim 1, wherein a diameter (D) of the opening (301) is measured in a direction perpendicular to the optical axis (400), and the diameter (D) changes monotonically along the optical axis (400).
